(19) United States
(12) Patent Application Publication
(10) Pub. No.: US 2016/0116709 A1
(43) Pub. Date: Apr. 28, 2016

(54) Photographic Lens Optical System

(71) Applicant: Kolen Co., Ltd., Seongnam-si (KR)

(72) Inventors: Jong Jin Lee, Seoul (KR); Chan Goo Kang, Gyeonggi-do (KR)

(21) Appl. No.: 14/920,380

(22) Filed: Oct. 22, 2015

(30) Foreign Application Priority Data
Oct. 24, 2014 (KR) 10-2014-0145399

(51) Int. Cl. G02B 13/00; G02B 9/34; G02B 27/00; G02B 13/04

(52) U.S. Cl. CPC G02B 13/004; G02B 13/04; G02B 9/34; G02B 27/0025

(57) ABSTRACT

Provided are lens optical systems. A lens optical system includes a first lens, a second lens, a third lens, and a fourth lens sequentially arranged in a direction from an object to an image sensor. The first lens may have a negative (−) refractive power and an entrance surface convex toward the object. The second lens may have a negative (−) refractive power and an exit surface concave toward the image sensor. The third lens may have a positive (+) refractive power and a meniscus shape convex toward the object. The fourth lens may have a positive (+) refractive power and a biconvex shape. The lens optical system may have a diagonal field of view FOV_D satisfying the following formula: 180°<FOV_D<220°, and may have a vertical field of view FOV_V satisfying the following formula: 125°<FOV_V<155°.

### FIELD OF THE INVENTION

One or more exemplary embodiments relate to an optical device, and more particularly, to a lens optical system for cameras.

### BACKGROUND OF THE INVENTION

Recently, the use of cameras including solid-state imaging devices such as charge coupled devices (CCDs) or complementary metal oxide semiconductor (CMOS) image sensors has greatly increased (hereinafter, cameras including solid-state imaging devices will be simply referred to as cameras). Also, the degree of pixel integration in solid-state imaging devices has increased to improve the resolution of cameras. Along with this, small and lightweight cameras have been developed by improving the performance of lens optical systems included in the cameras.

Lens optical systems for automotive cameras are generally constituted by five or more lenses so as to ensure a required optical performance. However, if a lens optical system includes many lenses, it may be ineffective in providing small and lightweight cameras. In addition, lens optical systems for automotive cameras are generally constituted by a plurality of glass lenses, and thus the manufacturing costs of the lens optical systems are high. Thus, there is a need for an optical lens system having a small size, a wide angle of view, and easily correctable aberration.

### SUMMARY OF THE INVENTION

One or more exemplary embodiments provide a lens optical system that is small (compact) and lightweight, and has a wide angle of view and a high degree of performance.

One or more exemplary embodiments provide a lens optical system that may be manufactured with low costs.

Additional aspects will be set forth in part in the description which follows and, in part, will be apparent from the description, or may be learned by practice of the presented embodiments.

According to one or more exemplary embodiments, a lens optical system includes a first lens, a second lens, a third lens, and a fourth lens sequentially arranged in a direction from an object to an image sensor on which an image of the object is formed, wherein the first lens has a negative (−) refractive power and an entrance surface convex toward the object, the second lens has a negative (−) refractive power and an exit surface concave toward the image sensor, the third lens has a positive (+) refractive power and a meniscus shape convex toward the object, and the fourth lens has a positive (+) refractive power and a biconvex shape.

The lens optical system may satisfy at least one of the following formulas.

180°<FOV_D<220°,125°<FOV_V<155° <Formula 1>

In Formula 1, FOV_D denotes a diagonal field of view of the lens optical system, and FOV_V denotes a vertical field of view of the lens optical system.

0.5<(R5+R6)/(R6−R5)<1.5 <Formula 2>

In Formula 2, R5 denotes a radius of curvature of an entrance surface of the third lens, and R6 denotes a radius of curvature of an exit surface of the third lens.

−3.5<SAG4/SAG3<−2.5 <Formula 3>

In Formula 3, SAG3 denotes a sagittal depth measured from an entrance surface of the second lens along an optical axis of the lens optical system, and SAG4 denotes a sagittal depth measured from the exit surface of the second lens along the optical axis.

20<Vd3<25 <Formula 4>

In Formula 4, Vd3 denotes an Abbe number of the third lens.

The lens optical system may satisfy at least two of Formulas 1 to 4.

The first lens may have an exit surface convex toward the object.

The entrance surface and the exit surface of the first lens may be spherical surfaces.

The second to fourth lenses may be aspherical lenses.

The entrance surface of the second lens may be concave toward the object.

The first lens may be a glass lens.

The second to fourth lenses may be plastic lenses.

An aperture stop may be disposed between the object and the image sensor.

The aperture stop may be disposed between the third lens and the fourth lens.

An infrared blocking element may be disposed between the object and the image sensor.

The infrared blocking element may be disposed between the fourth lens and the image sensor.

According to one or more exemplary embodiments, a lens optical system includes a first lens, a second lens, a third lens, and a fourth lens sequentially arranged in a direction from an object to an image sensor on which an image of the object is formed, wherein the first lens, the second lens, the third lens, and the fourth lens have negative (−), negative (−), positive (+), and positive (+) refractive powers, respectively, and the lens optical system satisfies Formula 1 below:

180°<FOV_D<220°,125°<FOV_V<155° <Formula 1>

where FOV_D denotes a diagonal field of view of the lens optical system, and FOV_V denotes a vertical field of view of the lens optical system.

The lens optical system may further satisfy Formula 2 below:

0.5<(R5+R6)/(R6−R5)<1.5 <Formula 2>

In Formula 2, R5 denotes a radius of curvature of an entrance surface of the third lens, and R6 denotes a radius of curvature of an exit surface of the third lens.

The lens optical system may further satisfy Formula 3 below:

−3.5<SAG4/SAG3<−2.5 <Formula 3>

In Formula 3, SAG3 denotes a sagittal depth measured from an entrance surface of the second lens along an optical axis of the lens optical system, and SAG4 denotes a sagittal depth measured from an exit surface of the second lens along the optical axis.

The lens optical system may further satisfy Formula 4 below:

20<Vd3<25 <Formula 4>

In Formula 4, Vd3 denotes an Abbe number of the third lens.

The first lens may be convex toward the object.

The second lens may be a biconcave lens.

The third lens may be convex toward the object.

The fourth lens may be a biconvex lens.

The first lens may be a spherical lens.

The second to fourth lenses may be aspherical lenses.

The first lens may be a glass lens.

The second to fourth lenses may be plastic lenses.

The lens optical system may further include an aperture stop and/or an infrared blocking element.

### BRIEF DESCRIPTION OF THE DRAWINGS

These and/or other aspects will become apparent and more readily appreciated from the following description of the embodiments, taken in conjunction with the accompanying drawings in which:

FIG. 1 is a cross-sectional view illustrating an arrangement of elements of a lens optical system according to a first exemplary embodiment;

FIG. 2 is a cross-sectional view illustrating an arrangement of elements of a lens optical system according to a second exemplary embodiment;

FIG. 3 is a cross-sectional view illustrating an arrangement of elements of a lens optical system according to a third exemplary embodiment;

FIG. 4A is a plan view illustrating a sensor region and an image region of a lens optical system according to an exemplary embodiment;

FIG. 4B is a plan view illustrating a sensor region and an image region of a lens optical system according to another exemplary embodiment;

FIG. 5 is a cross-sectional view illustrating a diagonal field of view FOV_D of a lens optical system according to an exemplary embodiment;

FIG. 6 is a cross-sectional view illustrating a vertical field of view FOV_V of a lens optical system according to an exemplary embodiment;

FIG. 7 is a cross-sectional view illustrating sagittal depths respectively measured from an entrance surface and an exit surface of a second lens of a lens optical system according to an exemplary embodiment;

FIG. 8 is an aberration diagram illustrating longitudinal spherical aberration, astigmatic field curvature, and distortion of the lens optical system of the first exemplary embodiment;

FIG. 9 is an aberration diagram illustrating longitudinal spherical aberration, astigmatic field curvature, and distortion of the lens optical system of the second exemplary embodiment; and

FIG. 10 is an aberration diagram illustrating longitudinal spherical aberration, astigmatic field curvature, and distortion of the lens optical system of the third exemplary embodiment.

### DETAILED DESCRIPTION OF THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the exemplary embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, lens optical systems will be described with reference to the accompanying drawings according to exemplary embodiments. In the drawings, like reference numerals refer to like (or similar) elements.

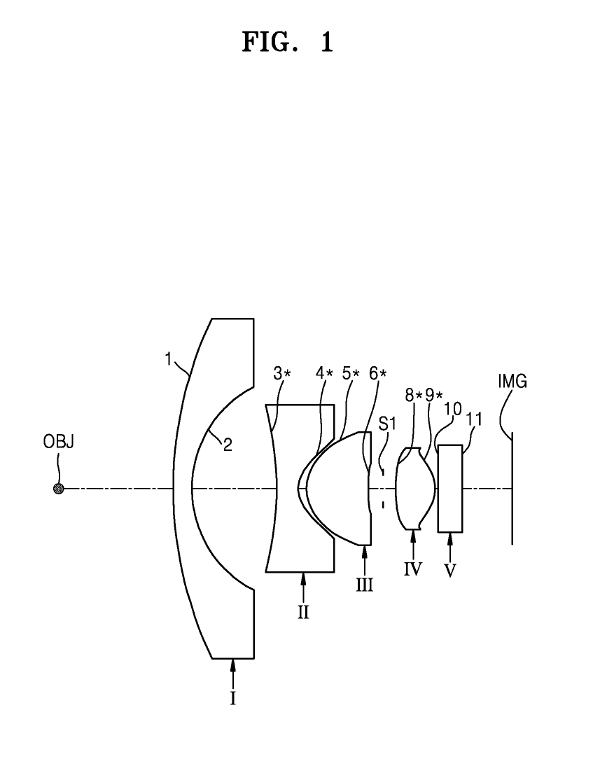

FIGS. 1 to 3 illustrate lens optical systems according to first to third exemplary embodiments.

Referring to FIGS. 1 to 3, each of the lens optical systems of the first to third exemplary embodiments includes a first lens I, a second lens II, a third lens III, and a fourth lens IV that are sequentially arranged in a direction from an object OBJ toward an image sensor IMG on which an image of the object OBJ is formed. The first lens I may have a negative (−) refractive power and may have an entrance surface 1 convex toward the object OBJ. An exit surface 2 of the first lens I may also be convex toward the object OBJ. Therefore, the first lens I may be a meniscus lens convex toward the object OBJ. The radius of curvature of the entrance surface 1 of the first lens I may be larger than the radius of curvature of the exit surface 2 of the first lens I. The second lens II may have a negative (−) refractive power and may have an exit surface 4* concave toward the image sensor IMG. An entrance surface 3* of the second lens II may be concave toward the object OBJ. Therefore, both surfaces (i.e., the entrance surface 3* and the exit surface 4*) of the second lens II may be concave. That is, the second lens II may be a biconcave lens. The third lens III may have a positive (+) refractive power and may be a meniscus lens that is convex toward the object OBJ. That is, both surfaces (i.e., an entrance surface 5* and an exit surface 6*) of the third lens III may be convex toward the object OBJ. The radius of curvature of the entrance surface 5* of the third lens III may be smaller than the radius of curvature of the exit surface 6* of the third lens III. The fourth lens IV may have a positive (+) refractive power, and both surfaces (i.e., an entrance surface 8* and an exit surface 9*) of the fourth lens IV may be convex. The first lens I may have the largest outer diameter among the first to fourth lenses I to IV. The outer diameters of the first to fourth lenses I to IV may decrease in the order of the first to fourth lenses I to IV. For example, the outer diameter of the second lens II may be smaller than an effective diameter (i.e., the outer diameter of an effective region) of the exit surface 2 of the first lens I.

At least one of the entrance surface 1 and the exit surface 2 of the first lens I may be a spherical surface. For example, both the entrance surface 1 and the exit surface 2 of the first lens I may be spherical. The first lens I may include glass. That is, the first lens I may be a glass lens. Since the first lens I is located outermost in the lens optical system, the first lens I may be exposed to the outside of a lens barrel. Therefore, if the first lens I first lens I includes glass, the strength of the first lens I may be improved, and thus the first lens I may be less damaged.

At least one of the second to fourth lenses II to IV may be an aspherical lens. In other words, at least one of an entrance surface 3*, 5*, or 8* and an exit surface 4*, 6*, or 9* of at least one of the second to fourth lenses II to IV may be an aspherical surface. For example, all the entrance surfaces 3*, 5*, and 8*, and the exit surfaces 4*, 6*, and 9* of the second to fourth lenses II to IV may be aspherical surfaces. At least one of the second to fourth lenses II to IV may include a plastic material. For example, all of the second to fourth lenses II to IV may be plastic lenses. If the second to fourth lenses II to IV are plastic lenses, aspherical surfaces may be easily formed on both sides of the second to fourth lenses II to IV. If a positive (+) refractive power is distributed to the third lens III and the fourth lens IV, and the second to fourth lenses II to IV are plastic lenses having aspherical surfaces, various kinds of aberration of the lens optical system may be easily corrected, and the performance of the lens optical system may be easily improved. In addition, since plastic lenses are easily manufactured/processed with relatively low costs compared to glass lenses, if the lens optical system includes a plurality of plastic lenses, the lens optical system may be manufactured with low costs.

An aperture stop S1 and an infrared blocking element V may be disposed between the object OBJ and the image sensor IMG. The aperture stop S1 may be disposed between the third lens III and the fourth lens IV. The infrared blocking element V may be disposed between the fourth lens IV and the image sensor IMG. The infrared blocking element V may be an infrared-cut filter. The positions of the aperture stop S1 and the infrared blocking element V may be changed.

Each of the lens optical systems of the exemplary embodiments may satisfy at least one of the following Formulas 1 to 4.

180°<FOV_D<220°,125°<FOV_V<155° <Formula 1>

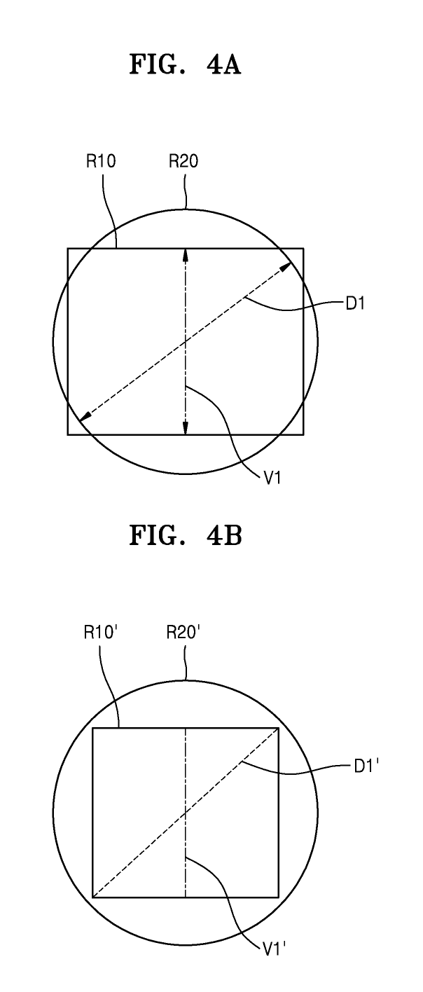

In Formula 1, FOV_D denotes the diagonal field of view of the lens optical system, and FOV_V denotes the vertical field of view of the lens optical system. In other words, FOV_D denotes the angle of view of the lens optical system corresponding to the maximum image height, and FOV_V denotes the angle of view of the lens optical system corresponding to a vertical image height. In this case, the vertical image height may be about 0.7 times the maximum image height. FOV_D and FOV_V will be further described with reference to FIGS. 4A, 4B, 5, and 6.

FIG. 4A is a plan view illustrating a sensor region R10 and an image region R20 of a lens optical system according to an exemplary embodiment. The sensor region R10 may correspond to an image sensor IMG, and the image region R20 may be an image region formed by the lens optical system. The image region R20 may be referred to as an “image circle.”

Referring to FIG. 4A, the sensor region R10 may have a quadrangular (rectangular) shape, and the image region R20 may have a circular shape. When the diameter of the image region R20 is equal to or smaller than the diagonal of the sensor region R10, a line D1 corresponding to the diameter of the image region R20 may correspond to the maximum image height (hereinafter the line D1 will be referred to as a diagonal D1 for convenience). In addition, a vertical line (central vertical line) V1 of the sensor region R10 may correspond to a vertical image height. In this case, the vertical image height may be about 0.7 times the maximum image height. In other words, the length of the vertical line V1 may be about 0.7 times the length of the diagonal D1.

FIG. 4B is a plan view illustrating a sensor region R10′ and an image region R20′ of a lens optical system according to another exemplary embodiment. Referring to FIG. 4B, when the diameter of the image region R20′ is greater than the diagonal D1′ of the sensor region R10′, the diagonal D1′ of the sensor region R10′ may correspond to the maximum image height. In addition, a vertical line (central vertical line) V1′ of the sensor region R10′ may correspond to a vertical image height. In this case, the vertical image height may be about 0.7 times the maximum image height.

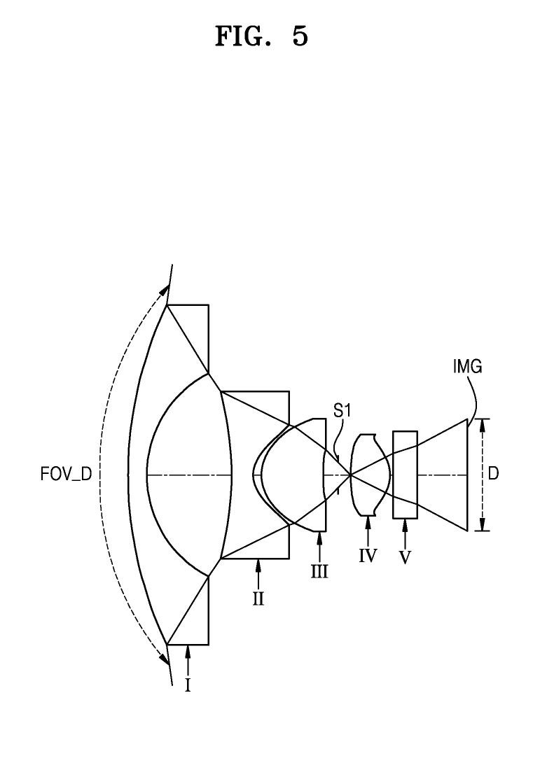

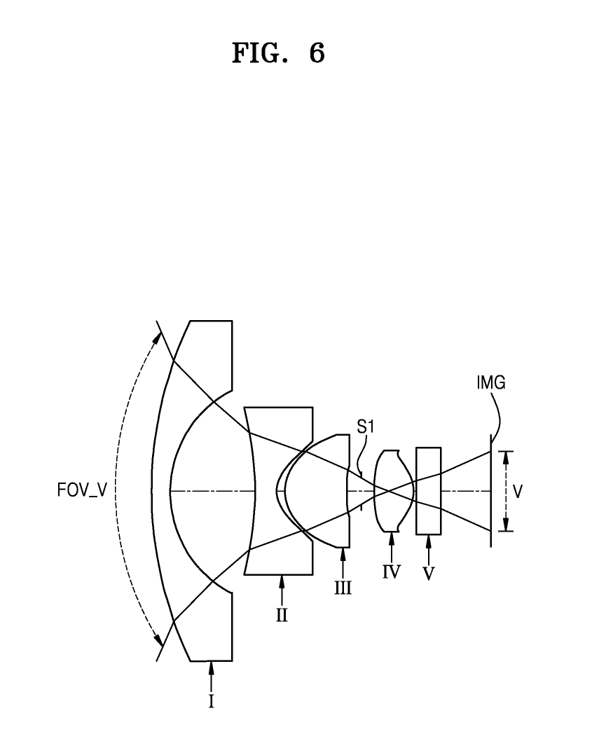

In Formula 1, FOV_D refers to the angle of view of the lens optical system corresponding to the diagonal D1 or D1′ illustrated in FIG. 4A or 4B, and FOV_V refers to the angle of view of the lens optical system corresponding to the vertical line V1 or V1′ illustrated in FIG. 4A or 4B. This is illustrated in FIGS. 5 and 6. In FIG. 5, reference letter D may correspond to the diagonals D1 and D1′ illustrated in FIGS. 4A and 4B, and an angle of view corresponding to the reference letter D may be FOV_D. In FIG. 6, reference letter V may correspond to the vertical lines V1 and V1′ illustrated in FIGS. 4A and 4B, and an angle of view corresponding to the reference letter V may be FOV_V.

Formula 1 describes conditions for the angle of view of a lens optical system. That is, when the diagonal field of view FOV_D of a lens optical system is within the range of 180° to 220°, the vertical field of view FOV_V of the lens optical system is within the range of 125° to 155°. This may mean that the lens optical systems of the exemplary embodiments are super wide angle lens systems having a wide angle of view in diagonal and vertical directions. Therefore, images may be taken at a wide angle of view equal to or greater than 180° by using the lens optical systems of the exemplary embodiments. For example, the lens optical systems of the exemplary embodiments may be used as automotive optical systems.

0.5<(R5+R6)/(R6−R5)<1.5 <Formula 2>

In Formula 2, R5 denotes the radius of curvature of the entrance surface 5* of the third lens III, and R6 denotes the radius of curvature of the exit surface 6* of the third lens III.

Formula 2 describes conditions for determining the shape of the third lens III. In the exemplary embodiments, the radius of curvature R6 of the exit surface 6* of the third lens III may be greater than the radius of curvature R5 of the entrance surface 5* of the third lens III, and the radii of curvature R5 and R6 may satisfy Formula 2, thereby making it possible to optimally correcting the aberration of the lens optical system and improving the performance of the lens optical system using the third lens III. That is, it may be easy to manufacture optical systems having a compact size and a wide angle of view if the optical systems satisfy Formula 2.

−3.5<SAG4/SAG3<−2.5 <Formula 3>

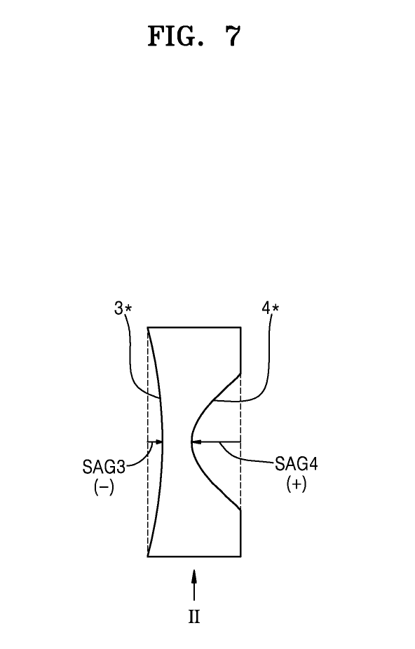

In Formula 3, SAG3 denotes a sagittal depth measured from the entrance surface 3* of the second lens II along an optical axis of the lens optical system, and SAG4 denotes a sagittal depth measured from the exit surface 4* of the second lens II along the optical axis. In other words, SAG3 denotes a distance measured from a tangent plane touching an edge portion of the entrance surface 3* to the vertex of the entrance surface 3* along the optical axis, and SAG4 denotes a distance measured from a tangent plane touching an edge portion of the exit surface 4* to the vertex of the exit surface 4* along the optical axis. The edge portions refer to end portions of effective lens regions (i.e., effective diameter regions) of the entrance surface 3* and the exit surface 4*. For example, SAG3 and SAG4 may be defined as illustrated in FIG. 7. As shown in FIG. 7, SAG3 may be referred to as having a negative (−) value, and SAG4 may be referred to as having a positive (+) value.

Formula 3 describes conditions for determining the shape of the second lens II, that is, a specific relationship between the sagittal depth SAG3 of the entrance surface 3* and the sagittal depth SAG4 of the exit surface 4* of the second lens II. The second lens II may be a biconcave lens, and the absolute value of the sagittal depth SAG4 of the exit surface 4* of the second lens II may be about 2.5 times to about 3.5 times the absolute value of the sagittal depth SAG3 of the entrance surface 3* of the second lens II. If the lens optical systems of the exemplary embodiments satisfy Formula 3, the lens optical systems may have a wide angle of view and a compact shape, and it may be easy to correct various aberrations of the lens optical systems and improve the performance of the lens optical systems.

20<Vd3<25 <Formula 4>

In Formula 4, Vd3 denotes the Abbe number of the third lens III. The Abbe number Vd3 is measured using the d-line.

Formula 4 is related to a material of the third lens III. That is, Formula 4 describes that the third lens III includes a material having an Abbe number of 20 to 25. Formula 4 may indicate that the third lens III includes a highly refractive material having a relatively high refractive index. For example, as the Abbe number of a plastic material decreases, the refractive index of the plastic material may increase. Formula 4 may be conditions for decreasing the chromatic aberration of the lens optical systems. If the lens optical systems satisfy Formula 4, the axial chromatic aberration and chromatic difference of magnification of the lens optical systems may be corrected, and the lens optical systems may have a compact size and improved performance.

In the first to third exemplary embodiments, values regulated by Formulas 1 to 4 are shown in Tables 1 to 4 below. In the tables below, fields of view FOV_D and FOV_V are given in degrees)(°, and R5, R6, SAG3, and SAG4 are given in millimeters (mm).

TABLE 1

| | | | Formula 1 | |
|---|---|---|---|---|
| | | | 180° < | 125° < |
| | | | FOV_D < | FOV_V < |
| Embodiments | FOV_D | FOV_V | 220° | 155° |
| First | 187.72 | 134.84 | Satisfied | Satisfied |
| embodiment | | | | |
| Second | 200.00 | 141.88 | Satisfied | Satisfied |
| embodiment | | | | |
| Third | 208.00 | 144.87 | Satisfied | Satisfied |
| embodiment | | | | |

TABLE 2

| Embodiments | R5 | R6 | Formula 2 |
|---|---|---|---|
| First embodiment | 1.4376 | 38.7306 | 1.077 |
| Second embodiment | 1.2557 | 13.2114 | 1.210 |
| Third embodiment | 1.3902 | 80.4795 | 1.035 |

TABLE 3

| | | | Formula 3 |
|---|---|---|---|
| Embodiments | SAG3 | SAG4 | −3.5 < SAG4/SAG3 < −2.5 |
| First embodiment | −0.350 | 1.156 | −3.303 |
| Second embodiment | −0.351 | 0.921 | −2.624 |
| Third embodiment | −0.401 | 1.224 | −3.052 |

TABLE 4

| | | Formula 4 |
|---|---|---|
| Embodiments | Vd3 | 20 < Vd3 < 25 |
| First embodiment | 22.43 | Satisfied |
| Second embodiment | 22.43 | Satisfied |
| Third embodiment | 22.43 | Satisfied |

Referring to Tables 1 to 4, the lens optical systems of the first to third embodiments satisfy Formulas 1 to 4.

In the lens optical systems of the exemplary embodiments, the second to fourth lenses II to IV may be formed of plastic when the shapes and dimensions thereof are considered. For example, all of the second to fourth lenses II to IV may be plastic lenses. Plastic lenses may be manufactured with low costs and may be easily formed/processed. According to the present disclosure, all of the second to fourth lenses II to IV may be plastic lenses, and this may guarantee various characteristics/advantages. However, materials that may be used to form the second to fourth lenses II to IV are not limited to plastic materials. If necessary, at least one of the second to fourth lenses II to IV may include glass. The first lens I may include glass as described above. However, if necessary, the first lens I may include a plastic material instead of glass. If the first lens I includes a plastic material, the surface of the first lens I may be coated with a predetermined material.

Hereinafter, the first to third exemplary embodiments will be described with reference to lens data and the accompanying drawings.

Tables 5 to 7 below show data such as the radii of curvature, thicknesses or intervals, refractive indexes, and Abbe numbers of the lenses of the lens optical systems shown in FIGS. 1 to 3. In Tables 5 to 7, R denotes a radius of curvature, D denotes the thicknesses of a lens, an interval between lenses, or an interval between adjacent elements, Nd denotes a refractive index of a lens measured using the d-line, and Vd denotes an Abbe number of a lens with respect to the d-line. If “*” is attached to the surface number of a surface, the surface is aspherical. R and D are given in millimeters (mm).

TABLE 5

| First | Surface | R | D | Nd | Vd |
|---|---|---|---|---|---|
| I | 1 | 12.4620 | 0.6000 | 1.7162 | 53.9380 |
| | 2 | 3.6530 | 2.7349 | | |
| II | 3* | −9.4999 | 0.7000 | 1.5340 | 55.8559 |
| | 4* | 0.8842 | 0.2654 | | |
| III | 5* | 1.4376 | 2.0000 | 1.6483 | 22.4336 |
| | 6* | 38.7306 | 0.4673 | | |
| | S1 | Infinity | 0.4111 | | |
| IV | 8* | 4.5573 | 1.2700 | 1.5340 | 55.8559 |
| | 9* | −1.1162 | 0.0747 | | |
| V | 10 | Infinity | 0.8000 | | |
| | 11 | Infinity | 1.5988 | | |
| | IMG | Infinity | 0.0070 | | |

TABLE 6

| Second | Surface | R | D | Nd | Vd |
|---|---|---|---|---|---|
| I | 1 | 12.0732 | 0.6000 | 1.7162 | 53.9380 |
| | 2 | 3.4298 | 2.6309 | | |
| II | 3* | −8.2186 | 0.6000 | 1.5340 | 55.8559 |
| | 4* | 0.8326 | 0.1336 | | |
| III | 5* | 1.2557 | 1.9986 | 1.6483 | 22.4336 |
| | 6* | 13.2114 | 0.4070 | | |
| | S1 | Infinity | 0.2741 | | |
| IV | 8* | 3.9605 | 1.2269 | 1.5340 | 55.8559 |
| | 9* | −1.0214 | 0.0747 | | |
| V | 10 | Infinity | 0.7000 | | |
| | 11 | Infinity | 1.5864 | | |
| | IMG | Infinity | 0.0096 | | |

TABLE 7

| Third | Surface | R | D | Nd | Vd |
|---|---|---|---|---|---|
| I | 1 | 12.4790 | 0.6000 | 1.7162 | 53.9380 |
| | 2 | 3.6510 | 2.7363 | | |
| II | 3* | −10.4642 | 0.7000 | 1.5340 | 55.8559 |
| | 4* | 0.8391 | 0.2736 | | |
| III | 5* | 1.3902 | 2.0000 | 1.6483 | 22.4336 |
| | 6* | 80.4795 | 0.4624 | | |
| | S1 | Infinity | 0.3333 | | |
| IV | 8* | 4.9350 | 1.1800 | 1.5340 | 55.8559 |
| | 9* | −1.1014 | 0.0747 | | |
| V | 10 | Infinity | 0.8000 | | |
| | 11 | Infinity | 1.5870 | | |
| | IMG | Infinity | 0.0027 | | |

The focal length and angle of view (θ) of each of the lens optical systems of the first to third exemplary embodiments respectively illustrated in FIGS. 1 to 3 are shown in Table 8 below. Here, the angle of view (θ) corresponds to a diagonal field of view FOV_D described in Formula 1.

TABLE 8

| Embodiments | Focal length (f) [mm] | Angle of view (θ) [°] |
|---|---|---|
| First embodiment | 0.9 | 187.72 |
| Second embodiment | 0.88 | 200.00 |
| Third embodiment | 0.9 | 208.00 |

Each of the aspherical surfaces of the lenses of the lens optical systems of the first to third exemplary embodiments satisfies Formula 5 below (aspherical surface equation):

$$x = \frac{{c}^{′} {y}^{2}}{1 + \sqrt{1 - ( K + 1 ) {c}^{′ 2} {y}^{2}}} + {Ay}^{4} + {By}^{6} + {Cy}^{8} + {Dy}^{10} + {Ey}^{12} \qquad 〈 Formula 5 〉$$

In Formula 5, x denotes a distance measured from the vertex of a lens in the direction of the optical axis of the lens, y denotes a distance measured from the optical axis in a direction perpendicular to the optical axis, c′ denotes a reciprocal number (1/r) of a radius of curvature at the vertex of the lens, K denotes a conic constant, and A, B, C, D, and E denote aspherical surface coefficients.

Tables 9 to 11 below show aspheric surface coefficients of the lens optical systems of the first to third exemplary embodiments respectively illustrated in FIGS. 1 to 3. That is, Tables 9 to 11 show the aspherical surface coefficients of the entrance surfaces 3*, 5*, and 8*, and the exit surfaces 4*, 6*, and 9* of the lenses of Tables 5 to 7.

TABLE 9

| Surface | K | A | B | C | D | E |
|---|---|---|---|---|---|---|
| 3* | 0.0000 | −0.0021 | 0.0006 | −0.0000 | 0.0000 | — |
| 4* | −1.0546 | −0.0204 | −0.0035 | −0.0017 | 0.0003 | — |
| 5* | −0.6545 | 0.0234 | −0.0035 | 0.0000 | 0.0005 | — |
| 6* | 0.0000 | 0.1361 | 0.0093 | 0.0286 | 0.0287 | — |
| 8* | 0.0000 | −0.0541 | 0.1127 | −0.0473 | 0.0098 | — |
| 9* | −0.8900 | 0.0136 | 0.0294 | −0.0223 | 0.0144 | 0.0050 |

TABLE 10

| Surface | K | A | B | C | D | E |
|---|---|---|---|---|---|---|
| 3* | 0.0000 | −0.0022 | 0.0005 | 0.0000 | −0.0000 | — |
| 4* | −1.3686 | −0.0398 | 0.0000 | −0.0003 | 0.0001 | — |
| 5* | −0.7357 | −0.0242 | 0.0075 | 0.0013 | 0.0001 | — |
| 6* | 0.0000 | 0.2315 | 0.0466 | 0.1397 | 0.0943 | — |
| 8* | 0.0000 | −0.0238 | 0.2547 | −0.2347 | 0.0943 | — |
| 9* | −0.9546 | 0.0122 | 0.0865 | −0.0866 | 0.0840 | 0.0050 |

TABLE 11

| Surface | K | A | B | C | D | E |
|---|---|---|---|---|---|---|
| 3* | 0.0000 | −0.0028 | 0.0005 | −0.0000 | −0.0000 | — |
| 4* | −1.2133 | −0.0270 | −0.0002 | −0.0009 | 0.0001 | — |
| 5* | −0.6921 | −0.0032 | 0.0016 | 0.0012 | 0.0001 | — |
| 6* | 0.0000 | 0.1372 | 0.0486 | 0.0048 | 0.0479 | — |
| 8* | 0.0000 | −0.0495 | 0.1555 | −0.0666 | 0.0104 | — |
| 9* | −0.8895 | 0.0074 | 0.0627 | −0.0650 | 0.0485 | 0.0050 |

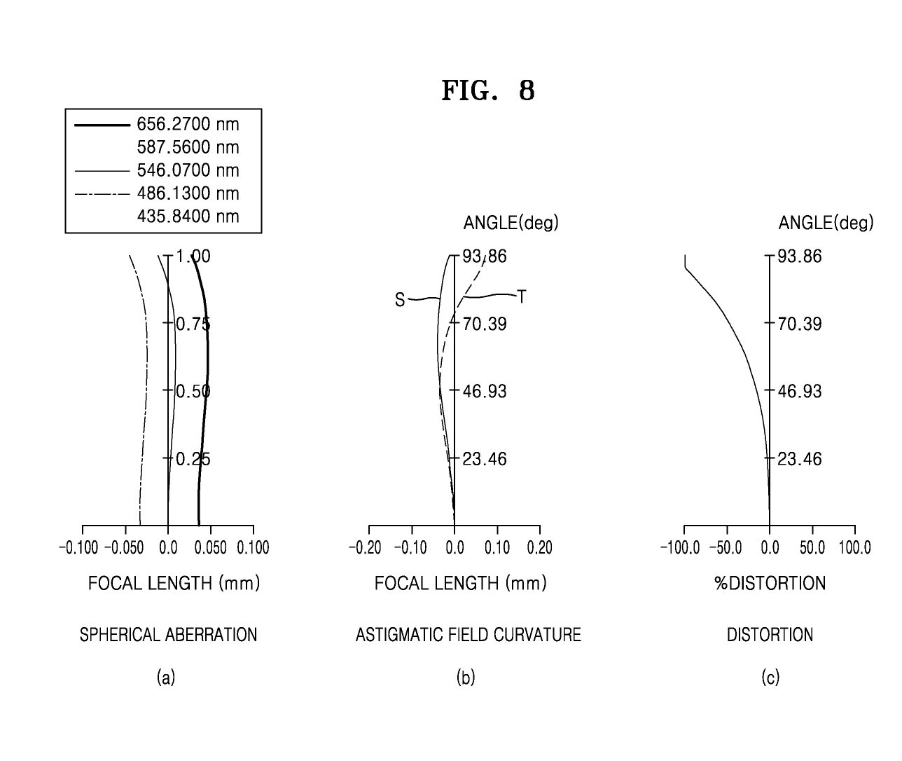

FIG. 8 is an aberration diagram illustrating longitudinal spherical aberration, astigmatic field curvature, and distortion of the lens optical system of the first exemplary embodiment (shown in FIG. 1) having the data shown in Table 5.

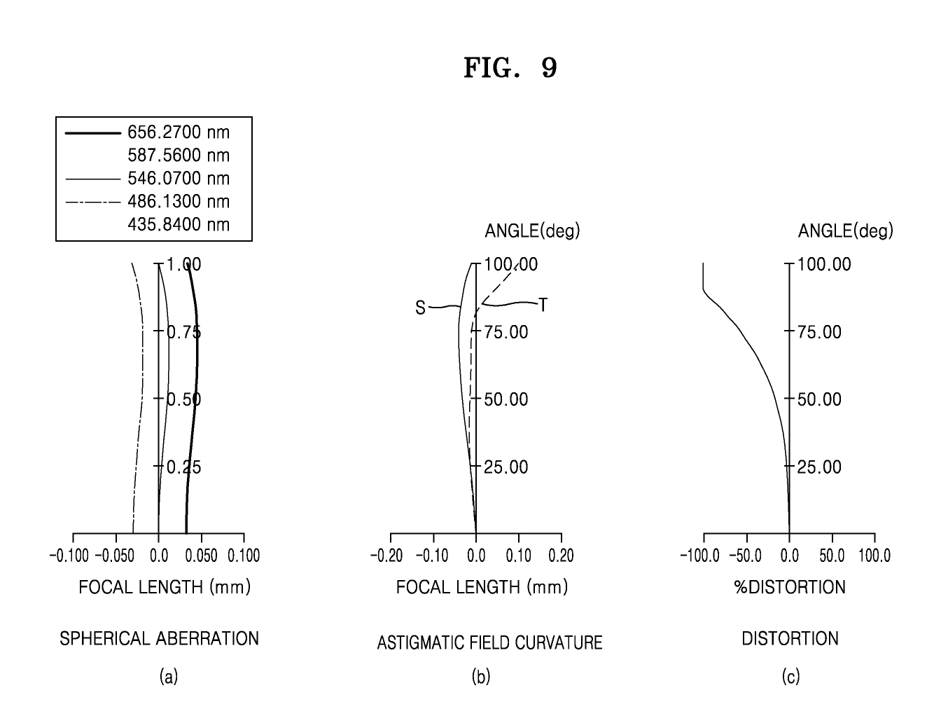

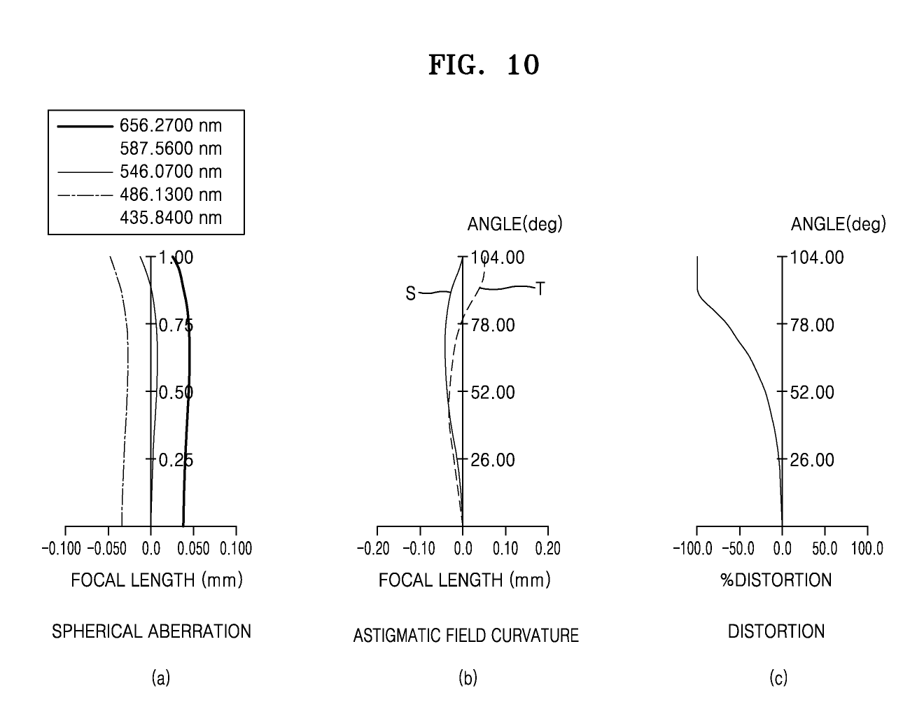

In FIG. 8, the graph (a) shows the spherical aberration of the lens optical system with respect to light having various wavelengths, and the graph (b) shows the astigmatic field curvature of the lens optical system including a tangential field curvature T and a sagittal field curvature S. Data of the graph (a) were obtained using light having wavelengths of 435.8400 nm, 486.1300 nm, 546.0700 nm, 587.5600 nm, and 656.2700 nm. Data of the graphs (b) and (c) were obtained using light having a wavelength of 546.0700 nm. Graphs of FIGS. 9 and 10 were obtained in the same manner.

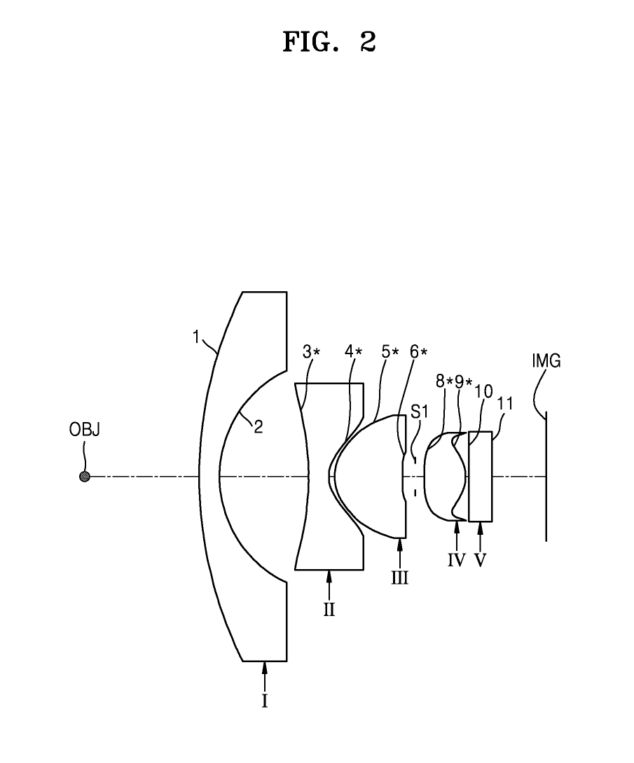

The graphs (a), (b), and (c) of FIG. 9 is an aberration diagram illustrating longitudinal spherical aberration, astigmatic field curvature, and distortion of the lens optical system of the second exemplary embodiment (shown in FIG. 2) having the data shown in Table 6.

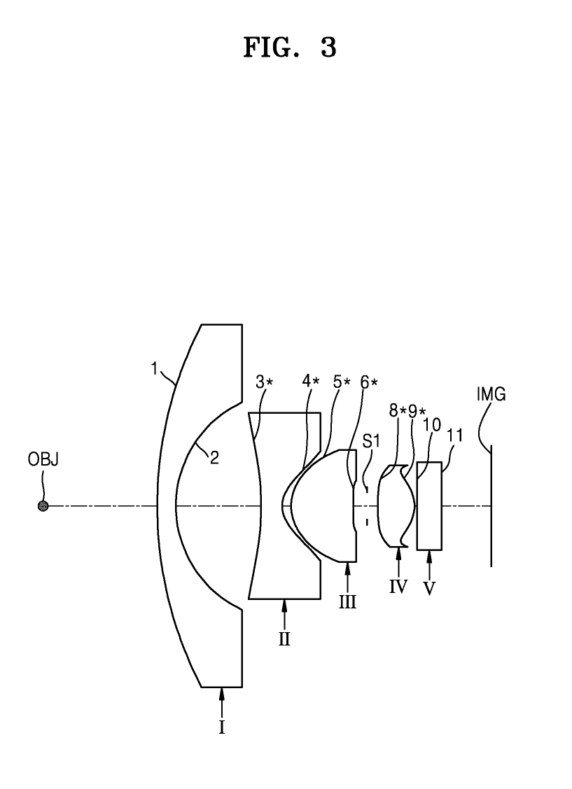

The graphs (a), (b), and (c) of FIG. 10 is an aberration diagram illustrating longitudinal spherical aberration, astigmatic field curvature, and distortion of the lens optical system of the third exemplary embodiment (shown in FIG. 3) having the data shown in Table 7.

As described above, each of the lens optical systems of the exemplary embodiments includes the first to fourth lenses I to IV sequentially arranged from the object side OBJ to the image sensor IMG and having negative (−), negative (−), positive (+), and positive (+) refractive powers. Each of the lens optical systems may satisfy at least one of Formulas 1 to 4. The lens optical systems may have relatively short total lengths and super wide angles of view (about 180° or greater), and various aberrations thereof may easily be corrected. That is, according to the exemplary embodiments, lens optical systems having small sizes, light weights, wide angles of view, and high resolution may be provided. In addition, each of the lens optical systems of the exemplary embodiments may be constituted by one glass lens and a plurality of plastic lenses. Therefore, the lens optical systems of the exemplary embodiments may be manufactured with low costs and may have a high degree of optical performance when compared to lens optical systems constituted by glass lenses.

The lens optical systems of the exemplary embodiments may be used as lens systems of automotive cameras. For example, the lens optical systems of the exemplary embodiments may be applied to various automotive devices such as around view monitoring (AVM) systems, black boxes, or rear cameras. Since the lens optical systems of the exemplary embodiments have compact structures and wide angles of view and are easy to correct aberrations, automotive devices employing the lens optical systems may have improved performance. In addition, the lens optical systems of the exemplary embodiments may be applied to various other devices as well as automotive devices.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments. For example, it will be apparent to those of ordinary skill in the art that although the shapes of the lenses of the lens optical systems of the exemplary embodiments are modified to some degree, the above-described effects can be obtained if the lens optical systems satisfy at least one of Formulas 1 to 4. In addition, those of ordinary skill in the art may use a blocking film as the infrared blocking element V instead of a filter. While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A lens optical system comprising a first lens, a second lens, a third lens, and a fourth lens sequentially arranged in a direction from an object to an image sensor on which an image of the object is formed,
wherein the first lens has a negative refractive power and an entrance surface convex toward the object,
the second lens has a negative refractive power and an exit surface concave toward the image sensor,
the third lens has a positive refractive power and a meniscus shape convex toward the object, and
the fourth lens has a positive refractive power and a biconvex shape.

2. The lens optical system of claim 1, wherein the lens optical system has a diagonal field of view FOV_D satisfying the following formula:
180°<FOV_D<220° <Formula>

3. The lens optical system of claim 1, wherein the lens optical system has a vertical field of view FOV_V satisfying the following formula:
125°<FOV_V<155° <Formula>

4. The lens optical system of claim 1, wherein a radius of curvature R5 of an entrance surface of the third lens and a radius of curvature R6 of an exit surface of the third lens satisfy the following formula:
0.5<(R5+R6)/(R6−R5)<1.5 <Formula>

5. The lens optical system of claim 1, wherein a sagittal depth SAG3 measured from an entrance surface of the second lens along an optical axis of the lens optical system, and a sagittal depth SAG4 measured from the exit surface of the second lens along the optical axis satisfy the following formula:
−3.5<SAG4/SAG3<−2.5 <Formula>

6. The lens optical system of claim 1, wherein the third lens has an Abbe number Vd3 satisfying the following formula:
20<Vd3<25 <Formula>

7. The lens optical system of claim 1, wherein the lens optical system satisfies at least two of the following formulas:
180°<FOV_D<220°,125°<FOV_V<155° <Formula>
0.5<(R5+R6)/(R6−R5)<1.5 <Formula>
−3.5<SAG4/SAG3<−2.5 <Formula>
20<Vd3<25 <Formula>
where FOV_D denotes a diagonal field of view of the lens optical system, FOV_V denotes a vertical field of view of the lens optical system, R5 denotes a radius of curvature of an entrance surface of the third lens, R6 denotes a radius of curvature of an exit surface of the third lens, SAG3 denotes a sagittal depth measured from an entrance surface of the second lens along an optical axis, SAG4 denotes a sagittal depth measured from the exit surface of the second lens along the optical axis, and Vd3 denotes an Abbe number of the third lens.

8. The lens optical system of claim 1, wherein the first lens has an exit surface convex toward the object.

9. The lens optical system of claim 1, wherein the entrance surface and an exit surface of the first lens are spherical surfaces.

10. The lens optical system of claim 1, wherein the second to fourth lenses are aspherical lenses.

11. The lens optical system of claim 1, wherein the second lens has an entrance surface concave toward the object.

12. The lens optical system of claim 1, wherein the first lens is a glass lens, and
the second to fourth lenses are plastic lenses.

13. The lens optical system of claim 1, further comprising an aperture stop between the third lens and the fourth lens.

14. The lens optical system of claim 1, further comprising an infrared blocking element between the fourth lens and the image sensor.

15. A lens optical system comprising a first lens, a second lens, a third lens, and a fourth lens sequentially arranged in a direction from an object to an image sensor on which an image of the object is formed,
wherein the first lens, the second lens, the third lens, and the fourth lens have negative (−), negative (−), positive (+), and positive (+) refractive powers, respectively, and
the lens optical system satisfies the following formula:
180°<FOV_D<220°
125°<FOV_V<155° <Formula>
where FOV_D denotes a diagonal field of view of the lens optical system, and FOV_V denotes a vertical field of view of the lens optical system.

16. The lens optical system of claim 15, wherein a radius of curvature R5 of an entrance surface of the third lens and a radius of curvature R6 of an exit surface of the third lens satisfy the following formula:
0.5<(R5+R6)/(R6−R5)<1.5 <Formula>

17. The lens optical system of claim 15, wherein a sagittal depth SAG3 measured from an entrance surface of the second lens along an optical axis of the lens optical system, and a sagittal depth SAG4 measured from an exit surface of the second lens along the optical axis satisfy the following formula:
−3.5<SAG4/SAG3<−2.5 <Formula>

18. The lens optical system of claim 15, wherein the third lens has an Abbe number Vd3 satisfying the following formula:
20<Vd3<25 <Formula>

19. The lens optical system of claim 15, wherein the first lens is convex toward the object,
the second lens is biconcave,
the third lens is convex toward the object, and
the fifth lens is biconvex.

20. The lens optical system of claim 15, wherein the first lens is a spherical lens, and
the second to fourth lenses are aspherical lenses.

21. The lens optical system of claim 15, wherein the first lens is a glass lens, and
the second to fourth lenses are plastic lenses.
